(19) United States
(12) Patent Application Publication
(10) Pub. No.: US 2006/0201968 A1
(43) Pub. Date: Sep. 14, 2006

(54) Method and apparatus for dispensing a beverage

(76) Inventor: Todd Degroff, Kensington, CT (US)

Correspondence Address: CANTOR COLBURN, LLP, 55 GRIFFIN ROAD SOUTH, BLOOMFIELD, CT, 06002, US

(21) Appl. No.: 11/076,699

(22) Filed: Mar. 10, 2005

(51) Int. Cl. B67D 5/60; B67D 5/64

(52) U.S. Cl. 222/131

(57) ABSTRACT

An apparatus for carrying and transporting an alcoholic beverage including a wearable device and a container disposed on the wearable device, the container configured to dispense a quantity of the alcoholic beverage.

### BACKGROUND OF INVENTION

(a) Field of Invention

The present invention relates generally to a method and apparatus for dispensing liquids. More specifically the invention relates to a wearable beverage dispensing system for providing a convenient method of dispensing a “shot” amount of beverage, particularly an alcoholic beverage.

(b) Description of Related Art

The use of mobile devices for dispensing beverages is well known in the art. Beverage dispensers are widely used in relation to sports and other remote activities. These dispensers are known to consist basically of familiar configurations, notwithstanding the myriad of designs encompassed by the crowded prior art which have been developed for the fulfillment of countless objectives and requirements.

Mobile methods of carrying and holding alcoholic beverages are also well known and widely used. Methods generally include means for retaining a specific container of an alcoholic beverage, such as an aluminum can. These containers are used by one person for sanitary or hygiene reasons and require a user to carry multiple containers when beverages are transported to an outside or remote function. The containers dispensed from are typically larger than a single serving, so the container must either be closed when not dispensing a beverage or remain open where, many times, there are no means to cap or close the container. Further, barware or other metering means are usually not available to measure the quantity of a beverage to be dispensed, such as when a “shot” amount of an alcoholic beverage is desired from the larger container.

Therefore, an apparatus is desired for carrying and transporting a beverage, particularly an alcoholic beverage, that overcomes the shortcomings of the prior art and offers improved beverage dispensing for beverage quantities, particularly for “shot” amounts.

### SUMMARY OF INVENTION

In an exemplary embodiment, the invention, which will described subsequently in greater detail, provides an apparatus for carrying and transporting an alcoholic beverage, where the beverage dispensing apparatus includes a wearable device and a container disposed on the wearable device, the container configured to dispense a quantity of the alcoholic beverage.

In another exemplary embodiment, the invention provides an apparatus for carrying and transporting a beverage, where the beverage dispensing apparatus includes a wearable device and a container disposed on the wearable device, the container being a syringe configured to dispense a quantity of the beverage.

In yet another exemplary embodiment, a method of dispensing an alcoholic beverage includes disposing a container on a wearable device and actuating the container to dispense the alcoholic beverage.

In another exemplary embodiment, a method of dispensing a beverage includes disposing a syringe on a body-mounted device and actuating the syringe to dispense the beverage.

There has thus been outlined, rather broadly, the more important features of the invention in order that the detailed description thereof that follows may be better understood and in order that the present contribution to the art may be better appreciated. There are additional features of the invention that will be described hereinafter and which will form the subject matter of the claims appended hereto.

These embodiments, along with the various features of novelty which characterize the invention are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

Referring now to the drawings wherein like elements are numbered alike in the several FIGURES:

FIG. 1 is a perspective view of a beverage dispensing apparatus in accordance with an exemplary embodiment;

FIG. 2 is a side view of the exemplary embodiment of FIG. 1;

FIG. 3 is a perspective view of another exemplary embodiment;

FIG. 4 is front-perspective view thereof in another embodiment; and

FIG. 5 is a plan view thereof.

### DETAILED DESCRIPTION OF THE INVENTION

While other devices fulfill their respective, particular objectives and requirements, the aforementioned prior art do not disclose a new apparatus for carrying and transporting a beverage, particularly alcoholic beverages. The inventive apparatus includes a container configured to dispense a quantity of a beverage, particularly “shot” amounts of an alcoholic beverage, the container including a syringe. The beverage dispensing system is adapted to be wearable and is intended to be both useful and entertaining. In this respect, the wearable apparatus for carrying and transporting a beverage substantially departs from conventional concepts and designs of the prior art, and in doing so provides an apparatus primarily developed for the purpose of providing a convenient and efficient method of dispensing alcoholic beverage shots.

Before explaining at least one embodiment of the invention in detail, it is to be understood that the invention is not limited in is application to the details of construction and to the arrangements of the components set forth in the following description or illustrated in the drawings. The invention is capable of other embodiments and of being practiced and carried out in various ways. The terms “a” and “an” herein to not denote a limitation of quantity, but rather denote the presence of at least one of the referenced item. Also, is it to be understood that the phraseology of description and should be regarded as limiting.

As such, those skilled in the art will appreciate that the conception, upon which this disclosure is based, may be readily utilized as a basis for the designing of other structures, methods and systems for carrying out the several purposes of the present invention. It is important, therefore, that the claims be regarded as including such equivalent constructions insofar as they do not depart from the spirit and scope of the present invention. Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

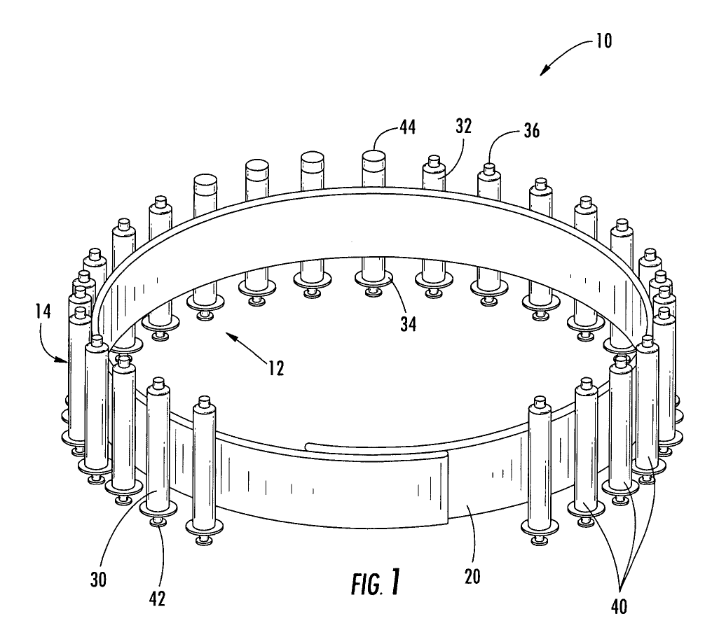

With reference now to the drawings, and in particular to FIGS. 1-5, a new wearable beverage dispensing system embodying the principles and concepts of the invention and generally designated by the reference numeral 10 will be described.

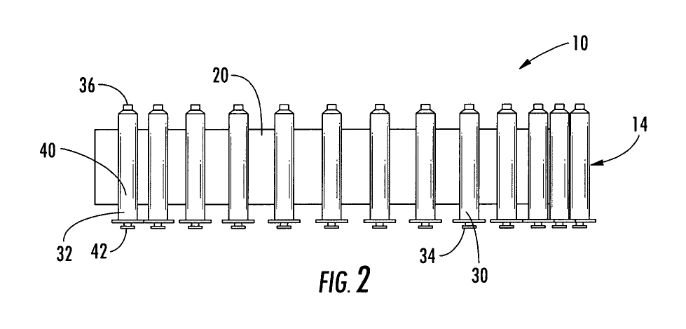

In a first exemplary embodiment, as best illustrated in FIGS. 1 and 2, a wearable beverage dispensing system 10 includes a belt 20, adaptable for adjustable positioning to a desired body part of a user, and a container 30 disposed on the belt 20. The container 30 is configured to dispense a quantity of a beverage, such as an alcoholic beverage. The quantity of the beverage may be what is commonly known as a “shot,” or an amount in a range of 1 milliliter (ml) to 30 milliliter (ml). One or more of a container 30, in one instance, in the form of a syringe 40, is disposed on the outer side 14 of the belt 20. In this particular embodiment, multiple containers 30 are disposed across the length of the belt 20, roughly evenly distributed, while not necessarily so.

The container 30 in the exemplary embodiments of FIGS. 1-5, have a main body 32, an actuating means 34 and an opening 36. The container 30, in the form of a syringe 40, includes actuating means 34 in the form of a plunger 42. FIG. 1 shows the opening 36 of some containers 30, covered by a cap 44, which is optional. The main body 32 holds the beverage to be dispensed and the opening 36 of the container 30 is configured sufficiently to allow the beverage to move from inside the main body 32 to outside of the container 30. When the cap 44 is removed from the main body 32, a beverage is dispensed through the opening 36 when the actuating means 34 is operated. In the example of a syringe 40, while the main body 32 is filled with the beverage, the plunger 42 would protrude from the main body 32. When the plunger 42 is depressed, the beverage would be forced through the opening 36 and ejected external of the syringe 40. It should be evident that other elements regarding the operation of a syringe 40 are well known and need not be addressed further.

While the container 30 is discussed hereinabove by way of example is a syringe 40, other containers are contemplated permitting the beverage to be dispensed in a “shot” amount. For example, a test tube or other container with particular actuating means may be used, permitting a “shot” amount of beverage be dispensed when the beverage dispensing system 10 is used.

While particular dimensions are not described for the belt 20 above, the belt 20 may be configured in any manner permitting it to be wearable on a desired body part of the user. Body parts include but are not limited to, a waist, wrist, ankle, neck, arm and leg and the like, as well as any combination including at least one of the foregoing. Additionally, it is anticipated that one or more of the beverage dispensing system 10 described herein may be wearable by a user at one time.

The belt may be made of a variety of materials, including but not limited to nylon, leather, elastic, mesh and the like. Similarly, the fastening means may be any number of apparatus, such as a buckle, ties, snaps, buttons, Velcro™, and the like, as well as any combination including at least one of the foregoing. In this way, the beverage dispensing apparatus 10 may be customized per a user's requirements, permitting the apparatus 10 to be wearable, positioned and repositioned as needed, and sufficient to support and maintain the filled containers 30.

While the beverage dispenser 10 is discussed herein as including a belt 20, it is contemplated that other garments or wearable objects may be used to successfully wear the beverage dispensing system 10. For example, a vest or apron may be employed to dispose a beverage container 30 thereon. Materials for these other garments or objects may be chosen with similar considerations of the belt 20 as described hereinabove.

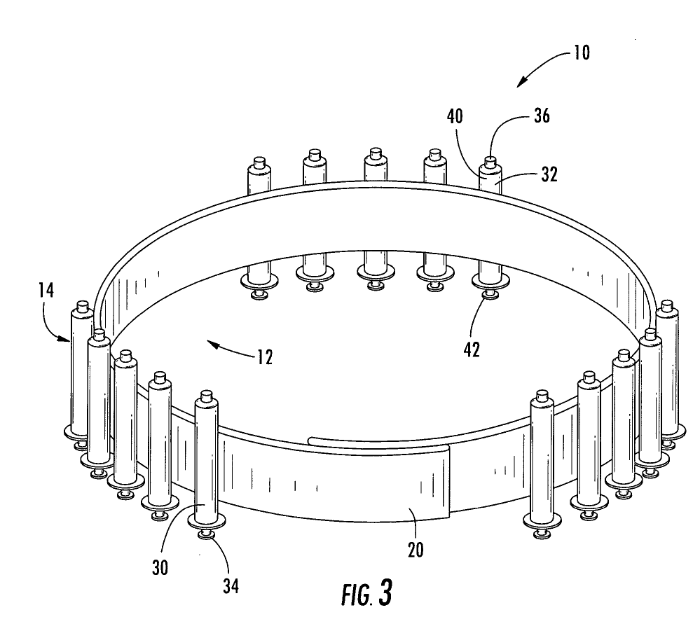

While the container 30 is disposed over the length of the belt 20 in FIGS. 1 and 2, any of a number of the container 30 disposed on the belt 20 is contemplated without departing from the spirit of the invention as discussed above. As an alternative embodiment, groupings of any of a number of the container 30 may also be disposed at intermittent or strategic locations on the belt 20, such as shown in FIG. 3. It is anticipated that the more than one container 30 may contain the same or a variety of flavors and types of beverages. The container 30 may also be configured in a variety of sizes and dimensions as needed for the amount and type of beverage to be dispensed.

The belt 20, to this point has been discussed as a one-piece configuration whereby the container 30 is disposed upon the belt 20. As a variation on the exemplary embodiments shown in FIG. 1-3, a two-piece configuration is also anticipated for the beverage dispensing system 10. Generally, the two-piece configuration also permits the beverage dispensing system 10 to be worn by a user and not significantly interfere with the user's movement, such as is discussed hereinabove.

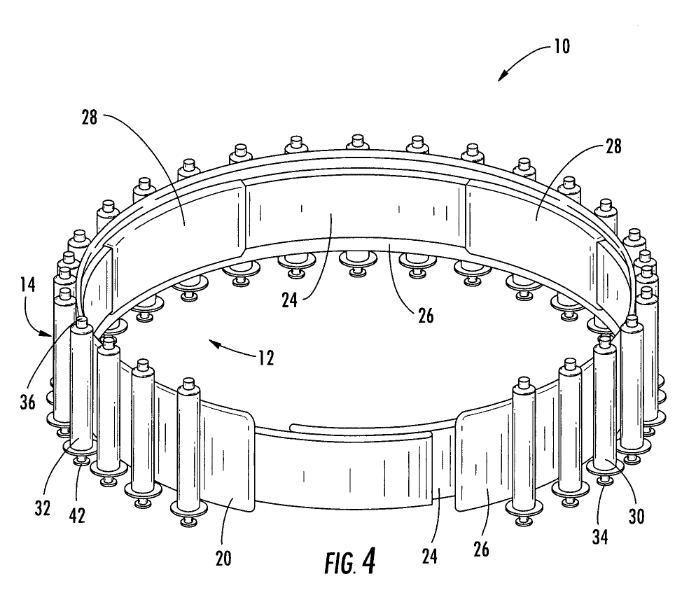

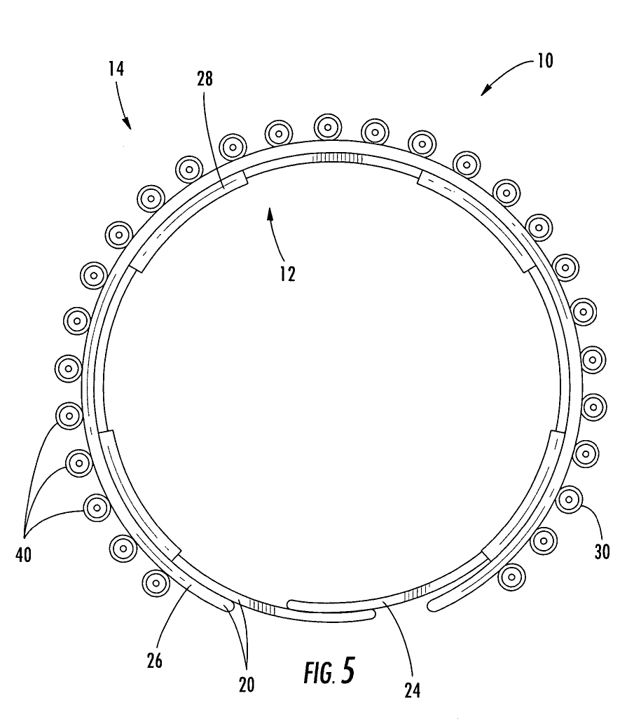

In an exemplary embodiment illustrated in FIGS. 4 and 5, the belt 20 includes a two-piece configuration, including an inner belt 24 and a belt sleeve 26. The inner belt 24 is retained to the belt sleeve 26 by belt bands 28 integrally formed on the inner side 12 of the belt sleeve 26. The inner belt 24 is woven through the belt bands 28 and is capable of sliding in an opposing direction of the belt sleeve 26 while retained by the belt bands 28. In this way, the inner belt 24 and the belt sleeve 26 may be positioned in a comfortable and convenient position with regard to each other, when the beverage dispensing system 10 is worn on a user.

While the two-piece configuration of the belt in the exemplary embodiment includes belt bands 28 to retain the inner belt 24 to a belt sleeve 26, the two pieces may be attached or retained by means other than bands 28. For example, the pieces may be joined by means including but not limited to snap or magnetic means, permitting the two pieces to stay secured to each other, especially while the beverage dispensing system 10 is worn by a user.

Further to the exemplary embodiment discussed above and shown in FIGS. 4 and 5, a two-piece configuration is contemplated where the inner belt 24 may be a common or even conventional belt generally worn by a user. Such a belt may be interchanged with one or more belt sleeves 26 having means for disposing different sizes, types, quantities and groupings of a beverage container 30. In this manner, a user could customize their beverage dispensing system 10 by matching a variety of one or more belt sleeves 26, based on a beverage or container preference, with any of a number of an inner belt 24 that is compatible with the sleeve 26. For example, a bar or tavern may keep a number of belt sleeves 26 on hand for their staff to use, the staff providing their own belt, which may again be a conventional belt 20 that the staff would have in their wardrobe, that is compatible with the sleeves 26.

In use, the wearable beverage dispensing system 10 is an apparatus that would allow the dispensing of a “shot” of an alcoholic beverage without needing to carry the entire container of the beverage nor attempting to estimate how much a single “shot” would be on dispensing.

In an exemplary embodiment, a method of dispensing an alcoholic beverage includes, disposing a container on a belt and dispensing the alcoholic beverage by actuating the container. In yet another exemplary embodiment, the container is a syringe, such as shown by way of example in FIGS. 1-5. The plunger 42 of the syringe is its actuating means 34. The actuation of the container causes the beverage held in the main body 32 of the container 30 to be ejected through the opening 36, to the outside of the container 30, into a receptacle. Such receptacle includes but is not limited to a glass, other drinking container, or in some cases, the mouth of a person consuming the beverage.

In the exemplary embodiments of FIGS. 1-4, the container 30 is disposed on the belt 20, with the opening 36 facing upward, anticipating a user to wear the beverage dispensing apparatus 10 in this direction so as to prevent dripping of the beverage from the container 30. Alternatively, the container 30 may be disposed with the opening facing downward. In such case, the optional cap 44 discussed hereinabove may be used to close the container 30, prevent dripping of the beverage, and the like.

As the container 30 is discussed above by way of example as being disposed with the opening 36 pointing upward or downward, it is also contemplated that the container 30 may also be disposed with the opening 36 facing sideways or in any other direction to accomplish a desired arrangement of containers 30s, which may allow for a variety of quantities of containers 30 being disposed on the belt 20. Alternative embodiments varying the direction and the quantity of a container 30 are contemplated permitting the beverage dispensing system 10 to be wearable which not significantly interfere with the movement of the user.

A container 30, in the exemplary embodiments of FIGS. 1-5, may be fixably or removably disposed on the belt 20. Where the container 30 is removably disposed on the belt 20, during use of the beverage dispensing system 10, the beverage may be dispensed while the container 30 is removed from or while it remains on the belt 20. Additionally, when a removably disposed container 30 is empty, it may be removed, cleaned, refilled and replaced on the belt 20 for another use of the beverage dispensing system 10.

A variety of means are contemplated for removably disposing the container. Examples of such means include but are not limited to a strap, a band, magnetic means or the like, as well as combinations including at least one of the foregoing, permitting a container 30 to be removed from the belt 20 as desired by the user, and to be held in place when the container 30 is to remain disposed on the belt 20.

A removably disposed container 30 may include means for cleaning and refilling the container 30. In yet another embodiment, a non-refillable container 30 may be pre-filled and removably attached to a belt 20, the belt 20 only being reusable, while the container 30 is simply discarded when emptied. In this case, a user could make a “one time” investment in a belt 20 and simply continue to procure container 30 “refills” of their favorite or particular variety of beverage to removably dispose on the belt 20.

In the case of a container 30 is fixably disposed on the belt 20, during use of the beverage dispensing system 10, the beverage may be dispensed without removing the container 30 from the belt 20. In yet another embodiment, the container 30 may be pre-filled and fixably attached to the belt 20, such that the entire apparatus 10 including the container 30 and belt 20, are discarded when the container 30 is emptied. For example, a container 30 may be adhesively attached such as with glue or epoxy, or may be integrally formed with the belt 20 or belt sleeve 26 preventing the container from being removable. Such an arrangement may be desired or preferred by a manufacturer for promotional items for their specific beverage brand or type.

In another exemplary embodiment of the method of dispensing a beverage, the container 30 may be filled with the beverage. Any number of means of transferring the beverage into the container 30 may be used, including but not limited to, directly pouring or drawing the beverage from a larger container or using a transfer aid, such as a funnel or the like. For example, a syringe 40, as discussed by way of example hereinabove, may be filled by placing the opening 36 in a larger container of the beverage to be dispensed and pulling on the actuating means 34, or the plunger 42, drawing the beverage into the main body 32. In yet another embodiment, the container 30 is procured pre-filled with a beverage, such as discussed above, the container 30 being either removably or fixably disposed on the beverage dispensing system 10.

The beverage, particularly an alcoholic beverage, in the beverage dispensing system 10 hereinabove described, may be in liquid form. It is also contemplated that a semi-liquid alcoholic beverage, such as what is better known as a “Jello™-shot,” may also be dispensed by beverage dispensing system 10.

The embodiments discussed herein of an apparatus to carry and transport a beverage including a belt 20, a container 30, a syringe 40 and a beverage, as well as the method of dispensing a beverage are provided purely by way of example and in no way limit the scope of the invention.

In sum, a beverage dispensing system 10 is described herein, particularly where the beverage is an alcoholic beverage. A wearable beverage dispensing system 10 is provided that overcomes the disadvantages of the prior art and offers improved dispensing of a quantity, or “shot” amount of an alcoholic beverage. The beverage dispensing system 10 includes a belt 20 that is flexible and adaptable to various wearable positions. Furthermore, the beverage dispensing system 10 is convenient and efficient to use and does not require excess measuring or peripheral parts to dispense an alcoholic beverage “shot.”

With respect to the above description the, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of this invention.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. The apparatus for carrying and transporting an alcoholic beverage, the apparatus comprising:
a wearable device; and
a container disposed on said wearable device, said container configured to dispense a quantity of the alcoholic beverage.

2. The apparatus of claim 1, wherein said wearable device is a garment, the garment comprising a vest, an apron or a belt.

3. The apparatus of claim 2, wherein said wearable device further comprises a belt sleeve.

4. The apparatus of claim 1, wherein said container is configured to dispense a “shot” quantity of the alcoholic beverage.

5. The apparatus of claim 1, wherein said container is one of a test tube, a syringe or an oral syringe.

6. The apparatus of claim 1, wherein said container has a capacity from about 1 milliliter to about 30 milliliters.

7. The apparatus of claim 1, wherein said container is fixably or removably disposed on said wearable device.

8. The apparatus of claim 1, wherein the alcoholic beverage is at least one of a liquid or semi-liquid.

9. The apparatus for carrying and transporting a beverage, the apparatus comprising:
a wearable device; and
a syringe disposed on said wearable device, said syringe configured to dispense a quantity of the beverage.

10. The apparatus of claim 9, wherein said wearable device is a garment, the garment comprising a vest, an apron or a belt.

11. The apparatus of claim 10, wherein said wearable device further comprises a belt sleeve.

12. The apparatus of claim 9, wherein said syringe is configured to dispense a “shot” quantity of the beverage.

13. The apparatus of claim 9, wherein said syringe has a capacity from about 1 milliliter to about 30 milliliters.

14. The apparatus of claim 9, wherein said syringe is an oral syringe.

15. The apparatus of claim 9, wherein said syringe is fixably or removably disposed on said wearable device.

16. The apparatus of claim 9, wherein the beverage is an alcoholic beverage.

17. The apparatus of claim 9, wherein the beverage is at least one of a liquid and semi-liquid.

18. The method of dispensing an alcoholic beverage, the method comprising:
disposing a container on a wearable device; and
actuating said container to dispense the alcoholic beverage.

19. The method of claim 18, wherein said wearable device is a garment, the garment comprising a vest, an apron or a belt.

20. The method of claim 19, further comprising disposing a belt sleeve on said wearable device.

21. The method of claim 18, wherein said disposing is removable or fixed.

22. The method of claim 18, wherein said container is one of a test tube, a syringe or an oral syringe.

23. The method of claim 18, wherein said actuating is conducted whether said container is disposed or said container is not disposed on said wearable device.

24. The method of claim 18, wherein said dispensing comprises a “shot” quantity of the alcoholic beverage, said “shot” quantity is in the range of about 1 milliliter to about 30 milliliters.

25. The method of claim 18, further comprising filling said container with the alcoholic beverage or procuring said container pre-filled with the alcoholic beverage.

26. The method of dispensing a beverage, the method comprising:
disposing a syringe on a wearable device; and
actuating said syringe to dispense the beverage.

27. The method of claim 26, wherein the beverage is an alcoholic beverage.

28. The method of claim 26, wherein said wearable device is a garment, the garment comprising a vest, an apron or a belt.

29. The method of claim 28, further comprising disposing a belt sleeve on said wearable device.

30. The method of claim 26, wherein said disposing is removable or fixed.

31. The method of claim 26, wherein said actuating is conducted whether said syringe is disposed or said syringe is not disposed on said wearable device.

32. The method of claim 26, wherein said dispensing comprises a “shot” quantity of the beverage, said “shot” quantity is in the range of about 1 millimeter to about 30 milliliters.

33. The method of claim 26, further comprising filling said syringe with the beverage or procuring said syringe pre-filled with the beverage.

34. A system for dispensing an alcoholic beverage, the system comprising:
means for disposing a container on a wearable device; and
means for actuating the container.

35. A system for dispensing a beverage, the system comprising:
means for disposing a syringe on a wearable device; and
means for actuating the syringe.
